(19) United States
(12) Patent Application Publication
(10) Pub. No.: US 2025/0060721 A1
(43) Pub. Date: Feb. 20, 2025

(54) METHODS AND APPARATUS TO MANAGE SENSOR DATA

(71) Applicant: Fisher Controls International LLC, Marshalltown, IA (US)

(72) Inventors: Shannon Jelken, Marshalltown, IA (US); Annette Lynn Latwesen, Marshalltown, IA (US)

(21) Appl. No.: 18/451,594

(22) Filed: Aug. 17, 2023

(51) Int. Cl. G05B 19/042; G01D 21/02

(52) U.S. Cl. CPC G05B 19/0426; G01D 21/02; G05B 2219/25428

(57) ABSTRACT

Systems, apparatus, articles of manufacture, and methods are disclosed. An example apparatus includes interface circuitry configured to connect with a field device, the field device including a first sensor, the field device powered by a power supply; computer readable instructions; and programmable circuitry powered by the power supply, the computer readable instructions to cause the programmable circuitry to: obtain a first measurement from the field device using a first communication protocol, the first measurement corresponding to the first sensor; obtain, without using the first communication protocol, a second measurement from a second sensor that is separate from the field device; and wirelessly transmit, using a second communication protocol, the first measurement and the second measurement to a controller.

### FIELD OF THE DISCLOSURE

This disclosure relates generally to field devices and, more particularly, to methods and apparatus to manage sensor data.

### BACKGROUND

Manufacturing or design environments may include a wide variety of actuators (e.g., valves, motors, engines, gears, fans, etc.). An actuator may exert mechanical forces of varying type, strength, and frequency based on the needs of an application. In some examples, multiple actuators connect to one another mechanically and/or logically. To manage such complex systems, a field device may monitor and/or control one or more actuators. The field device may use a standardized protocol to implement external communications such that other field devices and primary controllers can interpret data regardless of the type of connected actuators.

### SUMMARY

For methods and apparatus to manage sensor data, an example apparatus includes interface circuitry configured to connect with a field device, the field device including a first sensor, the field device powered by a power supply; computer readable instructions; and programmable circuitry powered by the power supply, the computer readable instructions to cause the programmable circuitry to: obtain a first measurement from the field device using a first communication protocol, the first measurement corresponding to the first sensor; obtain, without using the first communication protocol, a second measurement from a second sensor that is separate from the field device; and wirelessly transmit, using a second communication protocol, the first measurement and the second measurement to a controller.

### BRIEF DESCRIPTION OF THE DRAWINGS

FIG. 1 is a block diagram of an example environment including sensor coordinator device and a field device.

FIG. 2 is a block diagram of an example implementation of a 4-20 milliamp (mA) current loop used to power the field device and the sensor coordinator device of FIG. 1.

FIG. 3 is a block diagram of an example implementation of the sensor coordinator device of FIG. 1.

FIG. 4 is a block diagram of an example implementation of the field device of FIG. 1.

FIG. 5 is a flowchart representative of example machine readable instructions and/or example operations that may be executed, instantiated, and/or performed by example programmable circuitry to implement the sensor coordinator device of FIG. 3.

FIG. 6 is a flowchart representative of example machine readable instructions and/or example operations that may be executed, instantiated, and/or performed by example programmable circuitry of the sensor coordinator device of FIG. 3.

FIG. 7 is a block diagram of an example processing platform including programmable circuitry structured to execute, instantiate, and/or perform the example machine readable instructions and/or perform the example operations of FIG. 5 to implement the sensor coordinator device of FIG. 3.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine readable instructions of FIGS. 5 and 6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

One example communication protocol used by field devices is the Highway Addressable Remote Transducer (HART®) protocol. HART® is a bi-directional communication protocol that supports communication between two HART-enabled devices (e.g., a field device and a primary controller). In some examples, the two HART-enabled devices send and receive data over a wired connection using between 4-20 milliamps (mA) of current. In other examples, the two HART-enabled devices additionally implement a wirelessHART® communication protocol to send and receive HART® data without a wired connection. HART® and wirelessHART® communication protocols are commonly used across industrial settings due to the simplicity, reliability, and minimal cost of implementing a system that supports one or both protocols.

The HART® and wirelessHART® communication protocols describe data generated by HART-enabled devices. For example, a field device may include one or more internal sensors used to monitor an actuator. The field device may provide the internal sensor reading to a primary controller using HART® or wirelessHART® if both devices are HART-enabled.

While HART® and wirelessHART® establish communication across field devices and primary controllers, the protocols cannot be used by devices that are not HART-enabled. For example, suppose an application calls for measurement of an actuator using a third-party sensor that is not implemented within the field device connected to the actuator. A designer or manufacturer would have to implement both: (1) the HART-enabled field device to obtain the internal sensor readings and control the actuator, and (2) a separate communication system to obtain the third-party sensor readings. Such an additional communication system would add cost and complexity to the system, thereby limiting the applications in which some but not all devices are HART-enabled.

Example methods, apparatus, and systems described herein use HART® and wirelessHART® protocols to communicate data from devices that are not HART-enabled. An example sensor coordinator device includes analog and digital terminals to connect to both third-party sensor and HART-enabled devices using analog terminals, digital terminals, and wireless interface circuitry. The sensor coordinator device includes example protocol converter circuitry to package data recorded from a third-party sensor into the HART® or WirelessHART® protocol. The sensor coordinator device also includes event manager circuitry to monitor one or more thresholds such that a message received from a HART-enabled device or a reading from a third-party sensor can trigger an action to be performed by either the sensor coordinator device or a connected HART-enabled device. Accordingly, the example sensor coordinator device described herein enables the implementation of complex actuation and measurement systems using HART® or wirelessHART.

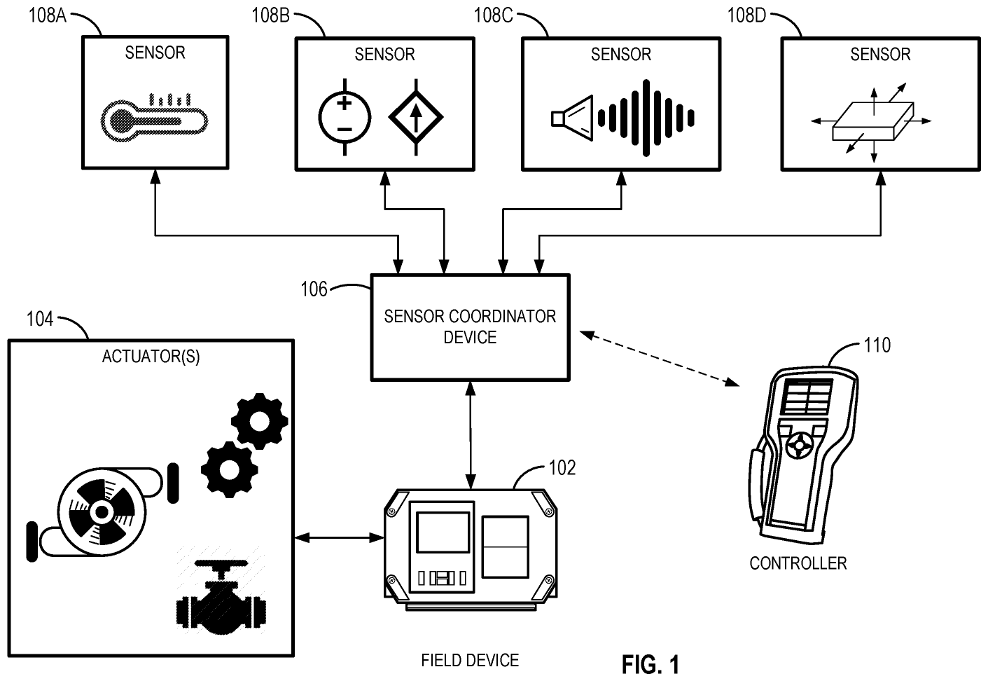

FIG. 1 is a block diagram of an example environment that includes example sensor coordinator device as described in accordance with the teachings of this disclosure. The environment of FIG. 1 includes an example field device 102, example sensor coordinator device 106, example sensors 108A, 108B, 108C, and 108D (collectively referred to as sensors 108), and a controller 110.

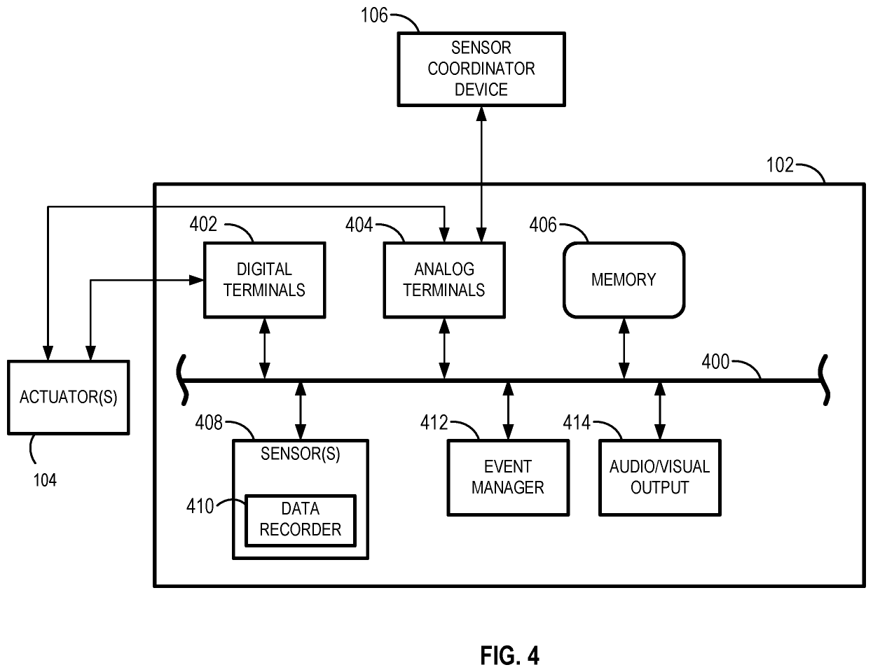

The field device 102 is a HART-enabled device that connects to both the sensor coordinator device 106 and to one or more of the actuators 104. The field device 102 measures, monitors, and/or controls the actuators 104. The field device 102 also communicates, via the wired HART® protocol, with the sensor coordinator device 106 to exchange data. Examples of data exchanged between the field device 102 and sensor coordinator device 106 may include but are not limited to measurements, performance metrics, instructions, etc. Examples of field devices 102 include but are not limited to Remote Terminal Units (RTUs), Programmable Logic Controllers (PLCs), Human Machine Interfaces, (HMIs), etc. The example of FIG. 1 includes one instance of the field device 102. In other examples, the environment implements a different number of field devices 102. The field device 102 is discussed further in connection with FIG. 4.

The actuators 104 exert mechanical forces to perform tasks. The actuators 104 may vary in size, cost, complexity, and function depending on the needs of an application. In some examples, an actuator is a tool being controlled within the environment of FIG. 1 to help produce a product. In other examples, an actuator is itself a product being tested/developed within the environment of FIG. 1. The actuators 104 may be implemented as a variety of components that include but are not limited to pumps, motors, engines, valves, robotic arms, levers, pullies, pistons, gears, springs, etc. The actuators 104 exert mechanical forces based on instructions received from the field device 102. A single field device 102 may connect to any number of actuators 104.

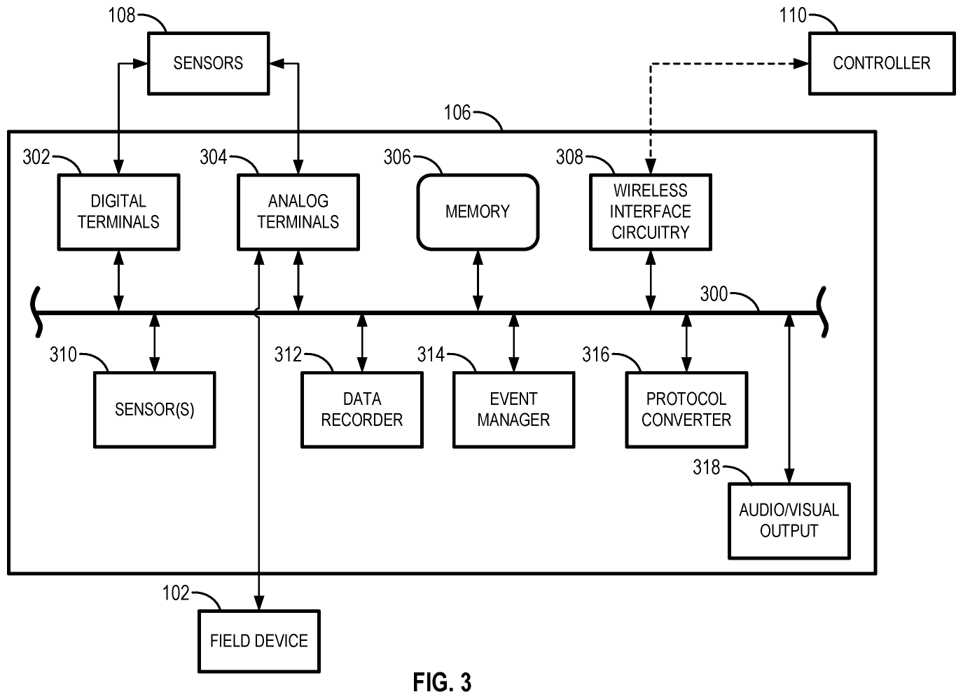

The sensor coordinator device 106 communicates with both HART-enabled devices and devices that are not HART-enabled in accordance with the teachings of this disclosure. For example, the sensor coordinator device 106 may have a first connection to the field device 102 that implements a wired HART® protocol, a second connection to the controller 110 that implements a wirelessHART® protocol, and a set of third connections to the sensors 108 that do not use HART® protocols. In some examples, the sensor coordinator device 106 may perform an action based on data received from a HART-enabled device. Additionally or alternatively, the sensor coordinator device 106 may cause the HART-enabled devices to perform actions based on inputs from the sensors 108 and internal logic within the sensor coordinator device 106. The example environment of FIG. 1 includes one instance of the sensor coordinator device 106 (e.g., one sensor coordinator device). In other examples, the field device 102 and/or the controller 110 may communicate with more than instance of the one sensor coordinator device 106. The sensor coordinator device 106 is discussed further in connection with FIG. 3.

The sensors 108 measure physical phenomena within the environment of FIG. 1 and exchange data with the sensor coordinator device 106. The sensors 108 may measure any type of physical phenomena. For example, the sensor 108A measures temperature, the sensor 108B measures voltage and current, the sensor 108C measures sound, and the sensor 108D measures position/orientation. While FIG. 1 displays four sensors, the sensor coordinator device 106 may connect to any number of sensors 108.

As used herein, the sensors 108 may be referred to as external sensors because the sensors are not implemented in or connected directly to the field device 102. Similarly, as used above and herein, the sensors 108 may be referred to as third party sensors because the sensors can be designed and manufactured independently of HART-enabled devices (e.g., the field device 102 and the sensor coordinator device 106).

The controller 110 communicates wirelessly with the sensor coordinator device 106 to obtain information corresponding to other components within the environment of FIG. 1. For example, the controller 110 may obtain measurements from both the sensors 108 and internal sensors of the field device 102. The controller 110 may then use the measurements to generate a user interface that includes a virtual instrument panel.

The controller 110 also communicates wirelessly with the sensor coordinator device 106 to provide instructions to the other components within environment of FIG. 1. For example, the controller 110 may instruct the sensor coordinator device 106 to change the sample rate of the sensor 108A to a certain value. In such an example, the controller 110 may determine the new value of the sample rate based on: (a) logic implemented by programmable circuitry within the controller 110 and/or (b) an external input (e.g., an input obtained via the foregoing user interface).

In the example of FIG. 1, the controller 110 communicates indirectly with the field device 102 via the sensor coordinator device 106. In other examples, the controller 110 additionally or alternatively communicates directly with the field device 102. In some examples, the controller 110 is referred to as a primary controller and the field device 102 is referred to as a secondary controller.

The controller 110 may include any type of programmable circuitry. Examples of programmable circuitry include but are not limited to programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs).

The example of FIG. 1 describes an implementation in which the controller 110 employs both the field devices 102 and the sensor coordinator device 106 to monitor and control an environment. In other examples, the controller 110 may employ only the sensor coordinator device 106 (e.g., without an accompanying field device) to monitor and control an environment.

In the example environment of FIG. 1, the field device 102 is HART-enabled while the sensors 108 are not HART-enabled. Furthermore, in the example of FIG. 1, the field device 102, the actuators 104, the sensor coordinator device 106, and the sensors 108 are located at a first location within the environment (e.g., a production floor of a manufacturing plant) while the controller 110 is located at a second location within the environment (e.g., a control room within the manufacturing plant). As a result, implementing two separate communication protocols within the environment may require extensive wiring (e.g., from the production floor to the control room) and extensive logic running on the controller 110 to handle both protocols independently.

Advantageously, the sensor coordinator device 106 enables the controller 110 to exchange data with both the field device 102 and the sensors 108 through a single, wireless communication protocol. Accordingly, the sensor coordinator device 106 supports the controller 110 with less cost and complexity than alternative solutions that use multiple communication protocols and/or multiple wires to connect the controller 110 directly to the sensors 108 and the field device 102.

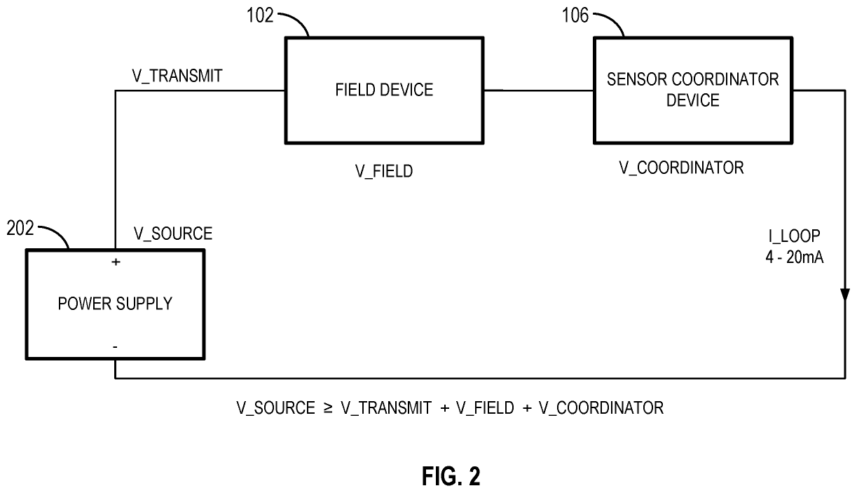

FIG. 2 is a block diagram of an example implementation of a 4-20 milliamp (mA) current loop used to power the field device and the sensor coordinator device of FIG. 1. FIG. 2 includes a power supply 202, the field device 102, and the sensor coordinator device 106.

A 4-20 mA current loop is used to provide both power and data within a single electrical connection. In general, a 4-20 mA current loop includes a power source, a transmitter, and a receiver connected to one another in series. In the example of FIG. 2, the power supply 202 powers both the field device 102 and the sensor coordinator device 106. The power supply 202 may be implemented within or controlled by the controller 110. HART® is a bi-directional protocol, so the field device 102 and the sensor coordinator device 106 can both function as transmitters and receivers. HART® is also a half-duplex protocol, so at any point in time, one of the field device 102 or the sensor coordinator device 106 functions as a transmitter while the other functions as a receiver.

The power source of a 4-20 mA current loop provides a voltage used by the transmitter and receiver to perform operations. The transmitter uses the voltage to produce a signal that has anywhere between 4 mA of current and 20 mA current. The receiver then interprets the amount of current (e.g. the amperage) as data encoded by the transmitter. In particular, 4 mA corresponds to 0% of the maximum value encoded by the transmitter, and 20 mA corresponds to 100% of the minimum value.

As an example, suppose that the field device 102 is transmitting a joint angle of a robot arm with a maximum value of 180°, and that the signal used to transmit the reading has an amperage of 12 mA. In such an example, the sensor coordinator device 106 determines the joint angle parameter is 90° because

$$\frac{( 12 mA - 4 mA )}{( 20 mA - 4 mA )} = 0.5 = \frac{90 °}{180 °} .$$

In FIG. 2, power supply and power consumption are modelled as voltage gain and voltage drops, respectively. For example, the power supply 202 produces a voltage labelled V_{SOURCE}. The voltage drops a first time by V_{TRANSMIT} due to transmission loss between the power supply 202 and the field device 102. The voltage drops a second time by V_{FIELD} due to the power consumption of the field device 102. If the voltage available to the field device 102 is less than V_{FIELD}, the field device 102 may malfunction or fail to power on.

In general, industry members can produce field devices 102 such that:

V_{SOURCE}≥V_{TRANSMIT}+V_{FIELD}

for a variety of applications. In some examples, the difference between V_{SOURCE} and the sum of V_{TRANSMIT}+V_{FIELD} is referred to as overhead. For example, consider an alternate 4-20 mA loop that includes only the field device and the power supply 202. If V_{SOURCE} is 20V, V_{TRANSMIT} is 5 V, and V_{FIELD} is 10 V, then the alternate 4-20 mA loop has a 5 V overhead that is not consumed.

Advantageously, the sensor coordinator device 106 is configured to power itself and the sensors 108 using overhead voltage within the 4-20 mA loop of FIG. 2. That is, the sensor coordinator device 106 can operate with a voltage drop, V_{COORDINATOR}, that is sufficiently small that:

V_{SOURCE}≥V_{TRANSMIT}+V_{FIELD}+V_{COORDINATOR}

even though the field device 102 may be designed without knowledge of V_{COORDINATOR}.

FIG. 3 is a block diagram of an example implementation of the sensor coordinator device 106 of FIG. 1. The sensor coordinator device 106 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the sensor coordinator device 106 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers. The example of FIG. 3 includes the field device 102, the sensor coordinator device 106, the sensors 108, and the controller 110. The sensor coordinator device 106 includes an example bus 300, example digital terminals 302, example analog terminals 304, example memory 306, example wireless interface circuitry 308, example sensors 310, example data recorder circuitry 312, example event manager circuitry 314, and example protocol converter circuitry 316.

The bus 300 refers to one or more physical connections (e.g., interconnects, copper traces, etc.) that enables communication between the internal components of the sensor coordinator device 106. The bus 300 may be implemented using one or more communication systems that meet pre-determined threshold power and latency requirements.

The digital terminals 302 refer to one or more physical endpoints that are configured to send/receive digital signals to/from an external source. Similarly, the analog terminals 304 refer to one or more physical endpoints that are configured to send/receive analog signals to/from an external source. Examples of terminals include but are not limited to pins, ports, copper pads, leads of electronic components, etc.

In examples described herein, the digital terminals 302 and the analog terminals 304 are used to exchange data with the sensors 108. A given sensor 108A may connect to one or both of the digital terminals 302 and the analog terminals 304. Both the digital terminals 302 and the analog terminals 304 may exchange any type of data. In some examples, the digital terminals 302 exchange discrete data (e.g., an instruction or command) while the analog terminals 304 exchange continuous data (e.g., a sensor measurement).

The analog terminals 304 also connect to the field device 102 to exchange data using the wired HART® protocol. For example, the field device 102 may use a pin within the analog terminals 304 to transmit a signal having between 4 mA and 20 mA of current as described above in connection with FIG. 2.

The memory 306 stores data used by the other components of the sensor coordinator device 106. For example, the memory 306 may store data including but not limited to sensor measurements received via the digital terminals 302 and/or the analog terminals 304, parameters used by the event manager circuitry 314, configurations used by the protocol converter circuitry 316 to convert a message, etc. The memory 306 may be implemented as any type of memory. For example, the memory 306 may be a volatile memory or a non-volatile memory. The volatile memory may be implemented by Synchronous Dynamic Random Access Memory (SDRAM), Dynamic Random Access Memory (DRAM), and/or any other type of RAM device. The non-volatile memory may be implemented by flash memory and/or any other desired type of memory device.

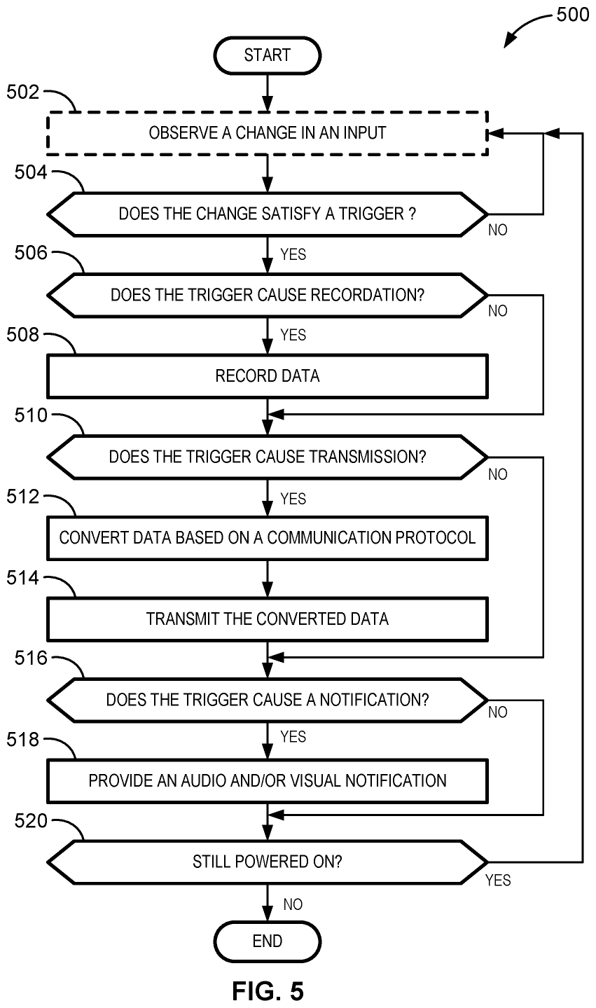

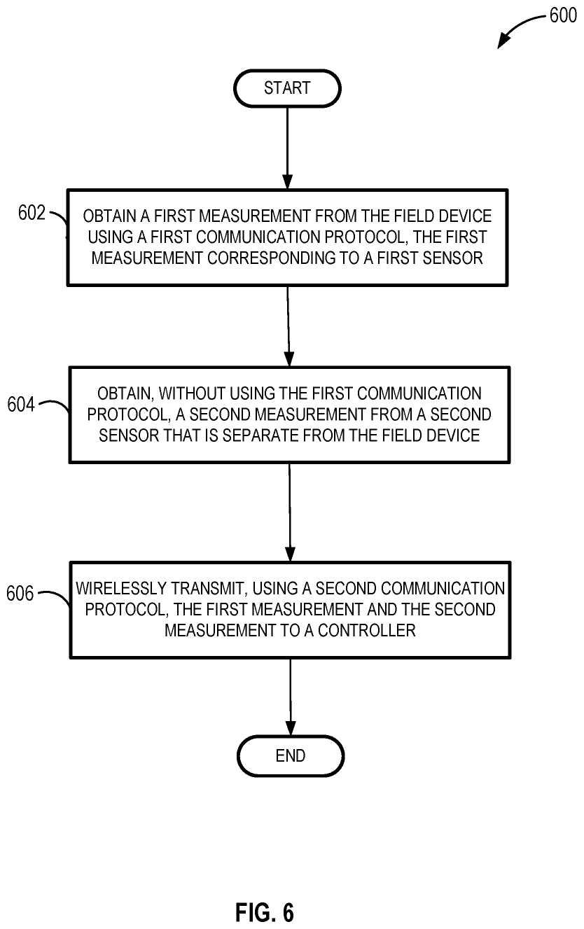

The wireless interface circuitry 308 communicates with the controller 110 using radio frequency emissions over a free space medium (e.g., without wires). The wireless interface circuitry 308 may include any communication protocol suitable for wireless communication with the controller 110. Examples of wireless communication protocols include but are not limited to wirelessHART®, Bluetooth® Low Energy, etc. The wireless interface circuitry 308 may include transceivers, antennas, and/or other hardware components required to implement one or more of the foregoing communication protocols. In some examples, the wireless interface circuitry 308 is instantiated by programmable circuitry executing wireless interface instructions and/or configured to perform operations such as those represented by the flowcharts of FIGS. 5 and 6.

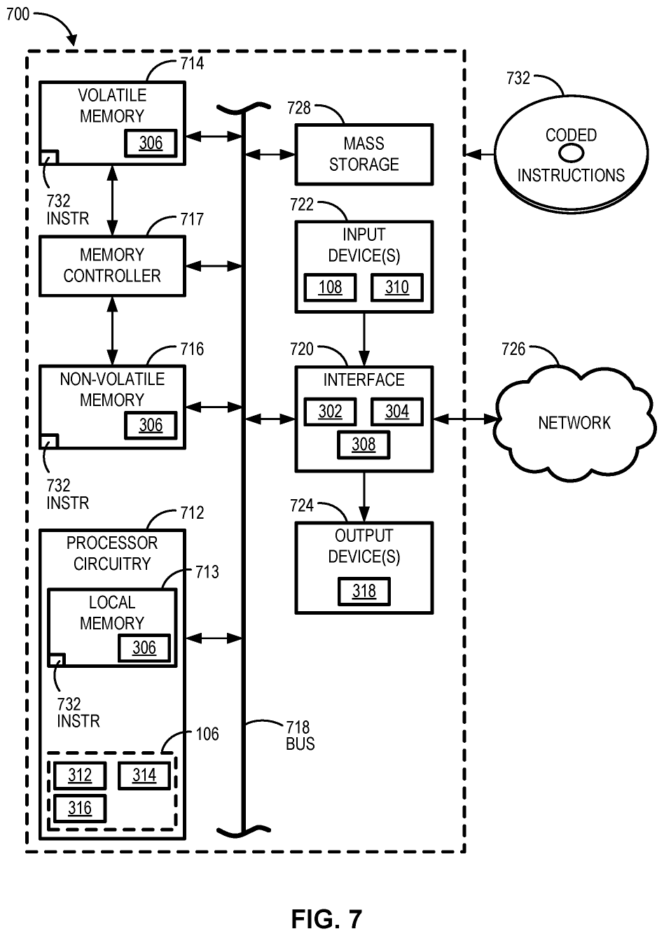

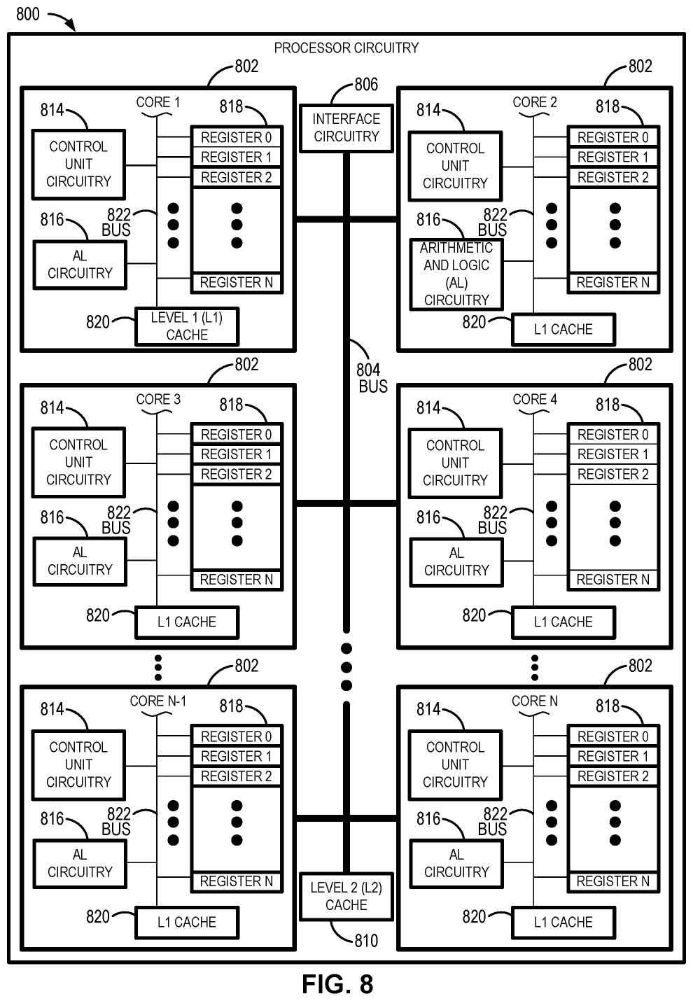

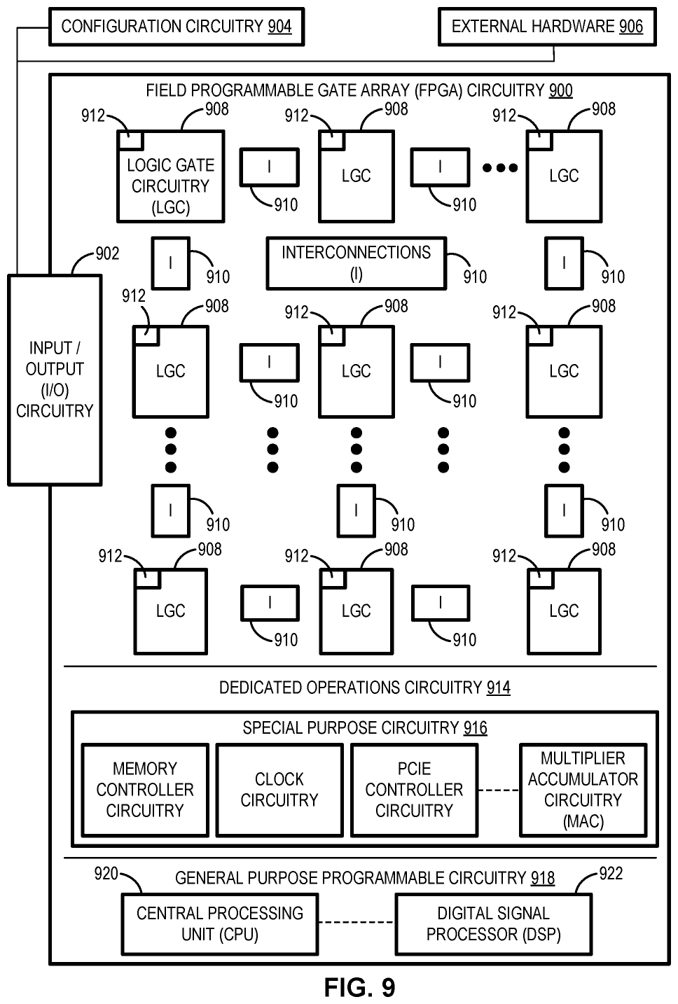

In some examples, the sensor coordinator device 106 includes means for communicating wirelessly. For example, the means for communicating wirelessly may be implemented by the wireless interface circuitry 308. In some examples, the wireless interface circuitry 308 may be instantiated by programmable circuitry such as the example programmable circuitry 712 of FIG. 7. For instance, the wireless interface circuitry 308 may be instantiated by the example microprocessor 800 of FIG. 8 executing machine executable instructions such as those implemented by at least blocks 514 of FIG. 5. In some examples, the wireless interface circuitry 308 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the wireless interface circuitry 308 may be instantiated by any other combination of hardware, software, and/or firmware. For example, the wireless interface circuitry 308 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The sensor(s) 310 refer to one or more sensors implemented within the packaging of the sensor coordinator device 106. Like the sensors 108, the sensors 310 may be referred to as third-party sensors and/or external sensors because they are designed and implemented separately from the field device 102. In some examples, the sensors 310 are not capable of transmitting via the HART® protocol.

The data recorder circuitry 312 obtains measurements from the sensors 108 and the sensors 310. For example, the sensor 108A may produce an output voltage (Vsensor) that is provided to the sensor coordinator device 106 through a pin within the analog terminals 304. In such examples, the data recorder circuitry 312 may sample Vsensor, filter noise from the sample, and convert the filtered output into a measurement. The data recorder circuitry 312 may determine when and how frequently to sample Vsensor, which filtering and conversion techniques to use, etc. The data recorder circuitry 312 also stores the measurements in the memory 306 via the bus 300. In some examples, the data recorder circuitry 312 is instantiated by programmable circuitry executing data recorder instructions and/or configured to perform operations such as those represented by the flowcharts of FIGS. 5 and 6.

In some examples, the sensor coordinator device 106 includes means for recording. For example, the means for recording may be implemented by the data recorder circuitry 312. In some examples, the data recorder circuitry 312 may be instantiated by programmable circuitry such as the example programmable circuitry 712 of FIG. 7. For instance, the data recorder circuitry 312 may be instantiated by the example microprocessor 800 of FIG. 8 executing machine executable instructions such as those implemented by at least blocks 508 of FIG. 5. In some examples, the data recorder circuitry 312 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the data recorder circuitry 312 may be instantiated by any other combination of hardware, software, and/or firmware. For example, the data recorder circuitry 312 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The event manager circuitry 314 identifies triggers and manages the actions of other components within the sensor coordinator device 106 based on the triggers. As used above and herein, a trigger refers to a change in the inputs to sensor coordinator device 106 that prompts an action to occur. An action may refer to any of the operations described in connection with FIG. 3. Examples of triggers and actions are discussed further in connection with FIG. 5. In some examples, the event manager circuitry 314 is instantiated by programmable circuitry executing event manager instructions and/or configured to perform operations such as those represented by the flowcharts of FIGS. 5 and 6.

In some examples, the sensor coordinator device 106 includes means for managing. For example, the means for managing may be implemented by the event manager circuitry 314. In some examples, the event manager circuitry 314 may be instantiated by programmable circuitry such as the example programmable circuitry 712 of FIG. 7. For instance, the event manager circuitry 314 may be instantiated by the example microprocessor 800 of FIG. 8 executing machine executable instructions such as those implemented by at least blocks 504-518 of FIG. 5. In some examples, the event manager circuitry 314 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the event manager circuitry 314 may be instantiated by any other combination of hardware, software, and/or firmware. For example, the event manager circuitry 314 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The protocol converter circuitry 316 places information into a format defined by a communication protocol. For instance, the protocol converter circuitry 316 packages measurements from the sensors 108 into Bluetooth® Low Energy packets or wirelessHART® packets. The protocol converter circuitry 316 also implements the wired HART® protocol by performing frequency key shift operations to encode information within two signals that are superimposed over one 4-20 mA physical connection.

The protocol converter circuitry 316 may perform any number of data manipulation operations to produce information in a desired format. Data manipulation operations that may be used in protocol conversion include but are not limited to adding, subtracting, re-ordering, encapsulating, etc. In some examples, the protocol converter circuitry 316 is instantiated by programmable circuitry executing protocol converter instructions and/or configured to perform operations such as those represented by the flowcharts of FIGS. 5 and 6.

In some examples, the sensor coordinator device 106 includes means for converting. For example, the means for converting may be implemented by the protocol converter circuitry 316. In some examples, the protocol converter circuitry 316 may be instantiated by programmable circuitry such as the example programmable circuitry 712 of FIG. 7. For instance, the protocol converter circuitry 316 may be instantiated by the example microprocessor 800 of FIG. 8 executing machine executable instructions such as those implemented by at least block 512 of FIG. 5. In some examples, the protocol converter circuitry 316 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the protocol converter circuitry 316 may be instantiated by any other combination of hardware, software, and/or firmware. For example, the protocol converter circuitry 316 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The audio/visual output 318 may refer to any hardware component that emits audio or light. For example, the audio/visual output 318 may be implemented by devices that include but are not limited to a speaker, a safety stack light, a beacon light, a screen, etc. In the example block diagram of FIG. 3, the audio/visual output 318 are implemented within the packaging of the sensor coordinator device 106. In other examples, one or more components of the audio/visual output 318 may be implemented externally from the sensor coordinator device 106.

In some examples, some or all of the audio/visual output 318 may be referred to as peripheral output components. Similarly, in some examples, the sensor coordinator device 106 implements or connects to peripheral input components (e.g., keyboards, touchscreens, e-stop buttons, etc.) not shown in FIG. 4.

The sensor coordinator device 106 uses the audio/visual output 318 to provide a notification. The notification may provide any type of information to a user of the sensor coordinator device 106. In some examples, the notification is an alert that informs the user of unexpected behavior (e.g., an error, a fault, an interrupt, etc.). In some examples, the notification is a status update (e.g., all systems are normal, a measurement has been completed, etc.).

In some examples, the sensor coordinator device 106 includes means for notifying. For example, the means for notifying may be implemented by the audio/visual output 318. In some examples, the audio/visual output 318 may be instantiated by programmable circuitry such as the example programmable circuitry 712 of FIG. 7. For instance, the audio/visual output 318 may be instantiated by the example microprocessor 800 of FIG. 8 executing machine executable instructions such as those implemented by at least block 518 of FIG. 5. In some examples, the audio/visual output 318 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the audio/visual output 318 may be instantiated by any other combination of hardware, software, and/or firmware. For example, the audio/visual output 318 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

FIG. 4 is a block diagram of an example implementation of the field device of FIG. 1. The field device 102 of FIG. 4 may be instantiated (e.g., creating an instance of, bring into being for any length of time, materialize, implement, etc.) by programmable circuitry such as a Central Processor Unit (CPU) executing first instructions. Additionally or alternatively, the field device 102 of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers. The field device 102 includes a bus 400, digital terminals 402, analog terminals 404, memory 406, sensor(s) 408, data recorder circuitry 410, and event manager circuitry 412.

Like the digital and analog terminals of FIG. 3, the digital terminals 402 and the analog terminals 404 refer to physical endpoints that are configured to send/receive signals to/from an external source. The digital terminals 402 connect to the actuators 104. In some examples, the digital terminals 402 also connect to peripheral components (now shown). The analog terminals 404 connect to both the actuators 104 and the sensor coordinator device 106.

The memory 406 stores data used by the other components of the field device 102. The memory 406 may be implemented by any type of volatile or non-volatile memory.

The sensors 408 measure physical phenomena of the surrounding environment (e.g., the actuators 104). The sensors 408 may be referred to as internal sensors because they are implemented within the packaging of the field device 102. In particular, the sensors 408 are implemented as one or more subsystems within the field device 102 that communicate with the rest of the field device 102 using the HART® protocol.

Each of the sensors 108 of FIG. 1, the sensors 310 of FIG. 3, and the sensors 408 of FIG. 4 may include any type of sensors. In some examples, a designer or manufacturer of the sensor coordinator device 106 may add functionality by implementing the sensors 310 with sensor types not included in the sensors 408. Similarly, a user of the sensor coordinator device 106 may add functionality by connecting the sensors 108 with sensor types not included in the sensors 408 or the sensors 310. In some examples, one or more of the sensors 108, 310, and 408 include a common sensor type.

Within the one or more subsystems that implement the sensors 408, the data recorder circuitry 410 obtains measurements by measuring voltages, filtering noise, and converting the voltage into a HART® compliant signal. The data recorder circuitry 312 may determine when and how frequently to sample various sensor voltages, which filtering and conversion techniques to use, etc.

Like the event manager circuitry 314 of FIG. 3, the event manager circuitry 412 identifies triggers and manages the actions of other components within the sensor coordinator device 106 based on the triggers. The event manager circuitry 412 of FIG. 4 may identify internal triggers from the sensors 408 or from inputs received via peripheral components implemented within the field device 102 (e.g., keyboards, touch screens, etc.). Additionally or alternatively, the field device 102 performs operations based on inputs received from an external source (e.g., the sensor coordinator device 106).

Like the audio/visual output 318, the audio/visual output 414 may refer to any hardware component that emits audio or light. The audio/visual output 414 may provide any type of notification to a user of the field device 102.

Without the sensor coordinator device 106, industry members seeking to use a single communication protocol to measure/control an environment are limited to the sensors 408 that were implemented within the field device 102 (e.g., sensors capable of communicating via the HART® protocol). Advantageously, the sensor coordinator device 106 implements protocol converter circuitry 316 that connects to third-party sensors (e.g., the sensors 108 and the sensors 310) that are not HART® enabled and converts the sensor outputs into a single communication protocol (e.g. HART®, wirelessHART®, Bluetooth® Low Energy, etc.). Accordingly, environments that include the sensor coordinator device 106 can support more types of sensors using a single communication protocol than environments that only use a field device 102. For instance, the Emerson® DVC6200 is a valve controller and an example implementation of the field device 102. The Emerson® DVC6200 can collect internal pressure and travel readings (e.g., the sensors 408 measure pressure and travel). With the sensor coordinator device 106, a system utilizing the Emerson® DVC6200 can obtain other measurements to measure valves, including but not limited to vibration, temperature, audio, etc.

While an example manner of implementing the sensor coordinator device 106 is illustrated in FIG. 3, one or more of the elements, processes, and/or devices illustrated in FIG. 3 may be combined, divided, re-arranged, omitted, eliminated, and/or implemented in any other way. Further, the example bus 300, the example digital terminals 302, the example analog terminals 304, the example memory 306, the example wireless interface circuitry 308, the example sensors 310, the example data recorder circuitry 312, the example event manager circuitry 314, the example protocol converter circuitry 316, and/or, more generally, the example sensor coordinator device 106 of FIG. 3, may be implemented by hardware alone or by hardware in combination with software and/or firmware. Thus, for example, any of the example bus 300, the example digital terminals 302, the example analog terminals 304, the example memory 306, the example wireless interface circuitry 308, the example sensors 310, the example data recorder circuitry 312, the example event manager circuitry 314, the example protocol converter circuitry 316, and/or, more generally, the example sensor coordinator device 106 of FIG. 3, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example sensor coordinator device 106 of FIG. 3 may include one or more elements, processes, and/or devices in addition to, or instead of, those illustrated in FIG. 3, and/or may include more than one of any or all of the illustrated elements, processes and devices.

Flowchart(s) representative of example machine readable instructions, which may be executed by programmable circuitry to implement and/or instantiate the sensor coordinator device 106 of FIG. 3 and/or representative of example operations which may be performed by programmable circuitry to implement and/or instantiate sensor coordinator device 106 of FIG. 3, are shown in FIGS. 5 and 6. The machine readable instructions may be one or more executable programs or portion(s) of one or more executable programs for execution by programmable circuitry such as the programmable circuitry 712 shown in the example programmable circuitry platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, read only memory (ROM), a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 5, many other methods of implementing the example sensor coordinator device 106 of FIG. 3 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 5 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 5 is a flowchart representative of example machine readable instructions and/or example operations 500 that may be executed, instantiated, and/or performed by programmable circuitry to implement the sensor coordinator device 106. The example machine-readable instructions and/or the example operations 500 of FIG. 5 begin when the event manager circuitry 314 optionally observes a change in an input. (Block 502). The input may come from any source connected to the event manager circuitry 314, including but not limited to the sensors 108 and 310, the memory 306, the field device 102, the controller 110, etc. Accordingly, the type of change identified in block 502 may depend on the source of the input. The changes may include but are not limited to a change in a voltage produced by one of the sensors 108 or the sensors 310, a new value stored in an address of the memory 306, a digital message received from the controller 110, a 4-20 mA analog message received from the field device 102, etc.

The event manager circuitry 314 determines whether the change satisfies a trigger. (Block 504). As used herein, a trigger refers to any condition that, when satisfied, causes the sensor coordinator device 106 to perform an action. The type of triggers may change based on the type of change observed in block 502. For example, a first trigger may be satisfied when an output voltage Vsensor received from one of the sensors 108 or 310 crosses a threshold voltage. A second trigger may be satisfied when the amount of data stored in a portion of the memory 306 crosses a threshold capacity (e.g., 850 kilobytes of a 1 megabyte cache are filled with sensor measurements). A third trigger may be satisfied when a message from the field device 102 or the controller 110 has a particular message. In examples where the block 502 is not implemented and the event manager circuitry 314 does not observe a change in input, a fourth trigger may be satisfied by the passage of a certain amount of time. The event manager circuitry 314 may additionally or alternatively check for other triggers based on the inputs and operations of the sensor coordinator device 106. If the event manager circuitry 314 determines the change does not satisfy a trigger (Block 504: No), control returns to block 502 where the event manager circuitry 314 optionally observes another change in an input.

If the event manager circuitry 314 determines the change does satisfy a trigger (Block 504: Yes), the event manager circuitry 314 determines whether the trigger causes recordation. (Block 506). Each trigger corresponds to at least one action that is performed or executed by the sensor coordinator device 106 when the trigger condition is satisfied. In some examples, the action is the recordation of sensor data. If the trigger does not cause recordation (Block 506: No), control proceeds to block 510. If the trigger does cause recordation (Block 506: Yes), the event manager circuitry 314 causes the data recorder circuitry 312 to record data. (Block 508). The data may correspond to a measurement recorded from either the sensors 108 or the sensors 310. In such examples, the source of the measurement is defined by the action that corresponds to the trigger.

The event manager circuitry 314 determines whether the trigger causes transmission. (Block 510). If the trigger does not cause transmission (Block 510: No), control proceeds to block 516. If the trigger does cause transmission (Block 510: Yes), the event manager circuitry 314 causes the protocol converter circuitry 316 to convert the data based on a communication protocol. (Block 512). The type of communication protocol may depend on the device that will receive the converted data, which is defined by the action that corresponds to the trigger. For example, if the action describes a transmission to the field device 102, the protocol converter circuitry 316 converts the data to the wired HART® protocol. Similarly, if the action describes a transmission to the controller 110, the protocol converter circuitry 316 converts the data to a wireless communication protocol used by the controller 110 (e.g., wirelessHART® or Bluetooth® Low Energy).

The event manager circuitry 314 causes the sensor coordinator device 106 to transmit the converted data. (Block 514). The event manager circuitry 314 uses the action that corresponds to the trigger as a basis for determining which component of the sensor coordinator device 106 performs the transmission. For example, if the action describes a transmission to the field device 102, the protocol converter circuitry 316 causes the analog terminals 304 to transmit the converted data over a wired connection. Similarly, if the action describes a transmission to the controller 110, the event manager circuitry 314 causes the wireless interface circuitry 308 to transmit the message.

The event manager circuitry 314 determines whether the trigger causes a notification. (Block 516). If the trigger does not cause a notification (Block 516: No), control proceeds to block 520. If the trigger does cause a notification (Block 516: Yes), the event manager circuitry 314 causes one or more components within the audio/visual output 318 to provide a notification. (Block 518). In some examples, the notification may be implemented by a light, a screen, or a speaker turning on. In some examples, the notification may be implemented by a light changing colors, a screen updating graphical components, or a speaker changing tones. The notification may additionally or alternatively be implemented by a different combination of audio and visual signals.

The event manager circuitry 314 determines whether the sensor coordinator device 106 is still powered on. (Block 520). If the sensor coordinator device 106 is still powered on (Block 520: Yes), control returns to block 502 where the event manager circuitry 314 optionally observes an additional change in an input. The machine readable instructions and/or operations end when the sensor coordinator device 106 is no longer powered (Block 520: No).

In the example flowchart of FIG. 5, the event manager circuitry 314 checks for and performs actions (e.g., recordation, transmission, notification) in serial for simplicity. In practice, the event manager circuitry 314 may check for and/or perform one or more actions in parallel.

The example flowchart of FIG. 5 provides an example of some actions that may be performed after a trigger is satisfied. In some examples, a trigger causes the sensor coordinator device 106 to perform actions not shown in FIG. 5. For example, a trigger could also cause the event manager to change a value in memory 306, change a configuration to alter the performance of programmable circuitry, etc.

A first action prompted by a first trigger may also satisfy a condition of a second trigger, thereby prompting a second action. Advantageously, the event manager circuitry 314 can combine triggers in this manner to form complex logical workflows. For example, suppose the passage of a set amount of time satisfies a first trigger. In response, the event manager circuitry 314 causes the data recorder circuitry 312 to begin recording a measurement from the sensor 108A. The measurements begin to change values within the memory 306, which satisfies a second trigger. In response, the event manager circuitry 314 causes the audio/visual output 318 to turn off a green light and turn on a yellow light (e.g., to indicate the sensor coordinator device 106 has transitioned from a standby mode to a measurement mode). The data recorder circuitry 312 changes a flag in memory upon the completion of the measurement, which satisfies a third trigger and causes the event manager circuitry 314 to access the new measurement values. If the new values are within an expected range, a fourth trigger is satisfied. In response to the fourth trigger, the event manager circuitry 314 causes the audio/visual output 318 to turn off the yellow light and turn on the green light. Alternatively, if the new values are not within the expected range, a fifth trigger is satisfied. In response to the fifth trigger, the event manager circuitry 314 causes the audio/visual output 318 to turn off the yellow light and turn on a red light (e.g., to indicate an error occurred). In response to the fifth trigger, the event manager circuitry 314 also causes the protocol converter circuitry 316 to package the new value into a wirelessHART® packet (e.g., so the error can be reported to the controller 110).

The foregoing example is one implementation of a logical workflow supported by the sensor coordinator device 106. In general, a logical workflow may include any number of triggers and actions. The triggers and actions that form a logical workflow can be connected in any manner. One or more instructions within a logical workflow may be pre-programmed into the sensor coordinator device 106, received from the field device 102, or received from the controller 110.

FIG. 6 is a flowchart representative of example machine readable instructions and/or example operations that may be executed, instantiated, and/or performed by example programmable circuitry of the sensor coordinator device of FIG. 3. The machine readable instructions and/or operations 600 begin when one or more of the analog terminals 304 obtain a first measurement from the field device 102, the first measurement corresponding to a first sensor within the sensors 408. (Block 602). In the example of FIG. 6, the first communication protocol is the wired HART® protocol because the field device 102 is HART-enabled and has a wired connection to the sensor coordinator device 106.

The event manager circuitry 314 causes the data recorder circuitry 312 to obtain, without using the first communication protocol, a second measurement from a second sensor that is separate from the field device 102. (Block 604). The second sensor may be one of the sensors 108 or one of the sensors 310. The data recorder circuitry 312 may determine configuration parameters (e.g., sample rate, filtering technique, etc.) used to obtain the second measurement.

The event manager circuitry 314 causes the wireless interface circuitry 308 to wirelessly transmit, using a second communication protocol, the first measurement and the second measurement to the controller 110. (Block 606). The second communication protocol may be implemented as wirelessHART®, Bluetooth® Low Energy, or another wireless protocol. To enable the wireless transmission, the event manager circuitry 314 causes the protocol converter circuitry 316 to convert the first measurement from the wired HART® protocol to the second communication protocol, and to package the second measurement into one or more packets formatted in the second communication protocol.

The event manager circuitry 314 may cause the operations of 604 and 606 in response to any number or type of triggers. In some examples, the output of block 602 satisfies a trigger which causes the execution of block 604, and the output of block 604 satisfies a trigger which causes the execution of block 606. In other examples, the triggers that cause the execution of block 604 and block 606 are unrelated.

The machine readable instructions and/or operations 600 is an example implementation of a logical workflow described in connection with FIG. 5. The sensor coordinator device 106 may implement other logical workflows in accordance with the teachings of this disclosure.

FIG. 7 is a block diagram of an example programmable circuitry platform 700 structured to execute and/or instantiate the example machine-readable instructions and/or the example operations of FIG. 5 to implement the sensor coordinator device 106 of FIG. 3. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, and/or microcontrollers from any desired family or manufacturer. The programmable circuitry 712 may be implemented by one or more semiconductor based (e.g., silicon based) devices. In this example, the programmable circuitry 712 implements the data recorder circuitry 312, the event manager circuitry 314, and the protocol converter circuitry 316.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716. In this example, the local memory 713, main memory 714, and/or main memory 716 implements the memory 306.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In this example, the interface circuitry 720 implement the digital terminals 302, the analog terminals 304, and the wireless interface circuitry 308.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, the sensors 108, the sensors 310, a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, the audio/visual output 318 (e.g., a light emitting diode (LED), an organic light emitting diode (OLED), a liquid crystal display (LCD), a cathode ray tube (CRT) display, an in-place switching (IPS) display, a touchscreen, a speaker, etc.). The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIGS. 5 and 6, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIGS. 5 and 6 to effectively instantiate the circuitry of FIG. 2 as logic circuits to perform operations corresponding to those machine readable instructions. In some such examples, the circuitry of FIG. 3 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 5 and 6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowcharts of FIGS. 5 and 6 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 5 and 6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 5 and 6. As such, the FPGA circuitry 900 may be configured and/or structured to effectively instantiate some or all of the operations/functions corresponding to the machine readable instructions of the flowcharts of FIGS. 5 and 6 as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIGS. 5 and 6 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIGS. 5 and 6 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine readable instructions represented by the flowcharts of FIGS. 5 and 6 to perform first operation(s)/function(s), the FPGA circuitry 900 of FIG. 9 may be configured and/or structured to perform second operation(s)/function(s) corresponding to a second portion of the machine readable instructions represented by the flowcharts of FIGS. 5 and 6, and/or an ASIC may be configured and/or structured to perform third operation(s)/function(s) corresponding to a third portion of the machine readable instructions represented by the flowcharts of FIGS. 5 and 6.

It should be understood that some or all of the circuitry of FIG. 3 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 3 may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 3 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

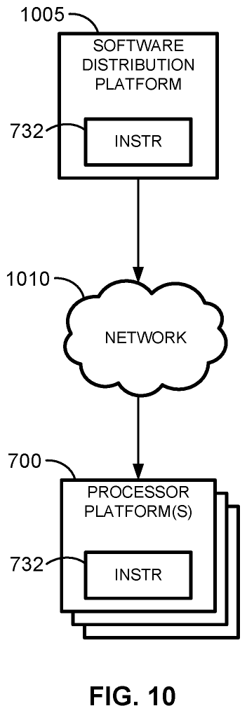

A block diagram illustrating an example software distribution platform 1005 to distribute software such as the example machine readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions of FIGS. 5 and 6, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of FIGS. 5 and 6, may be downloaded to the example programmable circuitry platform 700, which is to execute the machine readable instructions 732 to implement the sensor coordinator device 106. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that use HART® and wirelessHART® protocols to communicate data from devices that are not HART-enabled. Disclosed systems, apparatus, articles of manufacture, and methods improve the efficiency of using a computing device by packaging data recorded from third-party sensors into the HART® or WirelessHART® protocol, and by monitoring one or more thresholds such that a change in an input (e.g., a message received from a HART-enabled device, a reading from a third-party sensor, a new value in memory, etc.) can trigger an action to be performed by either the sensor coordinator device 106 or a connected HART-enabled device. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to manage sensor data are disclosed herein. Further examples and combinations thereof include the following.

Example 1 includes an apparatus comprising interface circuitry configured to connect with a field device, the field device including a first sensor, the field device powered by a power supply, computer readable instructions, and programmable circuitry powered by the power supply, the computer readable instructions to cause the programmable circuitry to obtain a first measurement from the field device using a first communication protocol, the first measurement corresponding to the first sensor, obtain, without using the first communication protocol, a second measurement from a second sensor that is separate from the field device, and wirelessly transmit, using a second communication protocol, the first measurement and the second measurement to a controller.

Example 2 includes the apparatus of example 1, wherein the power supply, the field device, and the apparatus form a 4-20 milliamp (mA) current loop.

Example 3 includes the apparatus of example 1, wherein the first communication protocol is a wired Highway Addressable Remote Transducer (HART®) protocol.

Example 4 includes the apparatus of example 1, wherein the second communication protocol is a Bluetooth® Low Energy (BLE) protocol.

Example 5 includes the apparatus of example 1, wherein the second communication protocol is a wireless Highway Addressable Remote Transducer (wirelessHART®) protocol.

Example 6 includes the apparatus of example 1, wherein the programmable circuitry records the second measurement in response to an instruction from the field device.

Example 7 includes the apparatus of example 1, wherein the computer readable instructions cause the programmable circuitry to transmit the first measurement and the second measurement in response to an instruction from the field device.

Example 8 includes the apparatus of example 1, wherein the computer readable instructions cause the programmable circuitry to transmit an instruction to the field device, the instruction to cause the field device to (a) record the first measurement from the first sensor and (b) transmit the first measurement to the apparatus.

Example 9 includes the apparatus of example 1, wherein the computer readable instructions cause the programmable circuitry to trigger an audio or visual notification based on the first measurement and the second measurement.

Example 10 includes the apparatus of example 1, wherein the programmable circuitry includes one or more of at least one of a central processor unit, a graphics processor unit, or a digital signal processor, the at least one of the central processor unit, the graphics processor unit, or the digital signal processor having control circuitry to control data movement within the programmable circuitry, arithmetic and logic circuitry to perform one or more first operations corresponding to machine-readable data, and one or more registers to store a result of the one or more first operations, the machine-readable data in the apparatus, a Field Programmable Gate Array (FPGA), the FPGA including logic gate circuitry, a plurality of configurable interconnections, and storage circuitry, the logic gate circuitry and the plurality of the configurable interconnections to perform one or more second operations, the storage circuitry to store a result of the one or more second operations, or Application Specific Integrated Circuitry (ASIC) including logic gate circuitry to perform one or more third operations.

Example 11 includes a non-transitory machine readable storage medium comprising instructions to cause programmable circuitry to at least obtain a first measurement from a field device using a first communication protocol, the first measurement corresponding to a first sensor within the field device, the field device powered by a power supply, obtain, without using the first communication protocol, a second measurement from a second sensor that is separate from the field device, and wirelessly transmit, using a second communication protocol, the first measurement and the second measurement to a controller.

Example 12 includes the non-transitory machine readable storage medium of example 11, wherein the power supply, the field device, and the non-transitory machine readable storage medium form a 4-20 milliamp (mA) current loop.

Example 13 includes the non-transitory machine readable storage medium of example 11, wherein the programmable circuitry records the second measurement in response to an instruction from the field device.

Example 14 includes the non-transitory machine readable storage medium of example 11, wherein the instructions cause the programmable circuitry to transmit the first measurement and the second measurement in response to an instruction from the field device.

Example 15 includes the non-transitory machine readable storage medium of example 11, wherein the instructions cause the programmable circuitry to transmit an instruction to the field device, the instruction to cause the field device to (a) record the first measurement from the first sensor and (b) transmit the first measurement to the non-transitory machine readable storage medium.

Example 16 includes the non-transitory machine readable storage medium of example 11, wherein the instructions cause the programmable circuitry to trigger an audio or visual notification based on the first measurement and the second measurement.

Example 17 includes a method comprising obtaining, with programmable circuitry, a first measurement from a field device using a first communication protocol, the first measurement corresponding to a first sensor within the field device, the field device powered by a power supply, obtaining, with the programmable circuitry and without using the first communication protocol, a second measurement from a second sensor that is separate from the field device, and wirelessly transmitting, with the programmable circuitry and using a second communication protocol, the first measurement and the second measurement to a controller.

Example 18 includes the method of example 17, wherein the power supply, the field device, and the programmable circuitry form a 4-20 milliamp (mA) current loop.

Example 19 includes the method of example 17, further including recording the second measurement in response to an instruction from the field device.

Example 20 includes the method of example 17, further including transmitting the first measurement and the second measurement in response to an instruction from the field device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry configured to connect with a field device, the field device including a first sensor, the field device powered by a power supply;
computer readable instructions; and
programmable circuitry powered by the power supply, the computer readable instructions to cause the programmable circuitry to:
obtain a first measurement from the field device using a first communication protocol, the first measurement corresponding to the first sensor;
obtain, without using the first communication protocol, a second measurement from a second sensor that is separate from the field device; and
wirelessly transmit, using a second communication protocol, the first measurement and the second measurement to a controller.

2. The apparatus of claim 1, wherein the power supply, the field device, and the apparatus form a 4-20 milliamp (mA) current loop.

3. The apparatus of claim 1, wherein the first communication protocol is a wired Highway Addressable Remote Transducer (HART®) protocol.

4. The apparatus of claim 1, wherein the second communication protocol is a Bluetooth® Low Energy (BLE) protocol.

5. The apparatus of claim 1, wherein the second communication protocol is a wireless Highway Addressable Remote Transducer (wirelessHART®) protocol.

6. The apparatus of claim 1, wherein the programmable circuitry records the second measurement in response to an instruction from the field device.

7. The apparatus of claim 1, wherein the computer readable instructions cause the programmable circuitry to transmit the first measurement and the second measurement in response to an instruction from the field device.

8. The apparatus of claim 1, wherein the computer readable instructions cause the programmable circuitry to transmit an instruction to the field device, the instruction to cause the field device to: (a) record the first measurement from the first sensor and (b) transmit the first measurement to the apparatus.

9. The apparatus of claim 1, wherein the computer readable instructions cause the programmable circuitry to trigger an audio or visual notification based on the first measurement and the second measurement.

10. The apparatus of claim 1, wherein the programmable circuitry includes one or more of:
at least one of a central processor unit, a graphics processor unit, or a digital signal processor, the at least one of the central processor unit, the graphics processor unit, or the digital signal processor having control circuitry to control data movement within the programmable circuitry, arithmetic and logic circuitry to perform one or more first operations corresponding to machine-readable data, and one or more registers to store a result of the one or more first operations, the machine-readable data in the apparatus;
a Field Programmable Gate Array (FPGA), the FPGA including logic gate circuitry, a plurality of configurable interconnections, and storage circuitry, the logic gate circuitry and the plurality of the configurable interconnections to perform one or more second operations, the storage circuitry to store a result of the one or more second operations; or
Application Specific Integrated Circuitry (ASIC) including logic gate circuitry to perform one or more third operations.

11. A non-transitory machine readable storage medium comprising instructions to cause programmable circuitry to at least:
obtain a first measurement from a field device using a first communication protocol, the first measurement corresponding to a first sensor within the field device, the field device powered by a power supply;
obtain, without using the first communication protocol, a second measurement from a second sensor that is separate from the field device; and
wirelessly transmit, using a second communication protocol, the first measurement and the second measurement to a controller.

12. The non-transitory machine readable storage medium of claim 11, wherein the power supply, the field device, and the non-transitory machine readable storage medium form a 4-20 milliamp (mA) current loop.

13. The non-transitory machine readable storage medium of claim 11, wherein the programmable circuitry records the second measurement in response to a change in input satisfying a trigger.

14. The non-transitory machine readable storage medium of claim 11, wherein the instructions cause the programmable circuitry to transmit the first measurement and the second measurement in response to a change in input satisfying a trigger.

15. The non-transitory machine readable storage medium of claim 11, wherein the instructions cause the programmable circuitry to transmit an instruction to the field device, the instruction to cause the field device to: (a) record the first measurement from the first sensor and (b) transmit the first measurement to the non-transitory machine readable storage medium.

16. The non-transitory machine readable storage medium of claim 11, wherein the instructions cause the programmable circuitry to trigger an audio or visual notification based on the first measurement and the second measurement.

17. A method comprising:
obtaining, with programmable circuitry, a first measurement from a field device using a first communication protocol, the first measurement corresponding to a first sensor within the field device, the field device powered by a power supply;
obtaining, with the programmable circuitry and without using the first communication protocol, a second measurement from a second sensor that is separate from the field device; and
wirelessly transmitting, with the programmable circuitry and using a second communication protocol, the first measurement and the second measurement to a controller.

18. The method of claim 17, wherein the power supply, the field device, and the programmable circuitry form a 4-20 milliamp (mA) current loop.

19. The method of claim 17, further including recording the second measurement in response to an instruction from the field device.

20. The method of claim 17, further including transmitting the first measurement and the second measurement in response to an instruction from the field device.
